(19) United States
(12) Patent Application Publication
(10) Pub. No.: US 2013/0000348 A1
(43) Pub. Date: Jan. 3, 2013

(54) EJECTOR, MOTIVE FLUID FOAMING METHOD, AND REFRIGERATION CYCLE APPARATUS

(75) Inventors: Shinya Higashiiue, Tokyo (JP); So Nomoto, Tokyo (JP); Hirokazu Minamisako, Tokyo (JP)

(73) Assignee: Mitsubishi Electric Corporation, Chiyoda-ku (JP)

(21) Appl. No.: 13/583,937

(22) PCT Filed: Mar. 31, 2010
(86) PCT No.: PCT/JP2010/055804

§ 371 Date: Sep. 11, 2012

(51) Int. Cl. B05B 7/04; F25B 1/06

(52) U.S. Cl. 62/500; 239/418; 239/408; 239/8

(57) ABSTRACT

A flow path of a nozzle included in an ejector includes a convergent taper portion in which the cross-sectional area of the flow path gradually decreases toward the downstream side, a cylindrical flow path extending from a downstream end of the convergent taper portion and being continuous for a predetermined length and in a cylindrical shape, and a divergent taper portion continuous with a downstream end of the cylindrical flow path and in which the cross-sectional area of the flow path gradually increases toward the downstream side. By providing the cylindrical flow path, a length of the divergent taper portion is reduced.

### TECHNICAL FIELD

The present invention relates to an ejector that uses velocity energy of a two-phase refrigerant ejected from a nozzle at a high velocity to circulate a refrigerant that is present therearound by drawing in the refrigerant.

### BACKGROUND ART

Some refrigeration cycle apparatuses utilize a two-phase ejector. The nozzle of a two-phase ejector includes a convergent taper portion in which the cross-sectional area of the flow path decreases in a flow direction from the nozzle inlet, a throat portion at which the cross-sectional area of the flow path is smallest, and a divergent taper portion in which the cross-sectional area of the flow path increases in the flow direction from the throat portion. A refrigerant having flowed into the nozzle undergoes pressure reduction while flowing through the convergent taper portion to the throat portion at an increasing velocity. When the pressure reaches a value equivalent or below the saturation liquid line, the refrigerant foams and expands. The refrigerant is promoted to expand in the divergent taper portion and undergoes further pressure reduction. Subsequently, the refrigerant in the form of a high-velocity, two-phase, gas-liquid refrigerant that has undergone pressure reduction and expansion is ejected from the nozzle.

The flow rate of the refrigerant passing through the nozzle is greatly affected by the diameter of the throat portion. Practically, the diameter of the throat portion ranges from 0.5 to 2.0 mm. The angles of the convergent taper portion and the divergent taper portion are desired to be gentle so that occurrence of eddies is suppressed. For example, it is known that the angle of the convergent taper portion is desirably about 5°, and the angle of the divergent taper portion is desirably 3° or smaller.

(1) To manufacture such a nozzle, the length of the flow path defined by the convergent taper portion and the divergent taper portion is to be about twenty times larger than the diameter of the throat portion. Therefore, in cases where such a nozzle is processed by cutting, deterioration of accuracy in the roundness of the flow path of the nozzle and damage to cutting tools frequently occur.
(2) If electric discharge machining is employed in the manufacturing process, cost increases.
(3) If casting is employed, the accuracy in finishing of the inner surface of the nozzle deteriorates. Therefore, casting is not suitable for mass production of nozzles.

To solve the above problems, in Patent Literature 1, the convergent taper portion is a two-stage taper, whereby the taper length is reduced and the ease of processing during manufacture of the nozzle is increased (FIG. 5 in Patent Literature 1).

### CITATION LIST

### Patent Literature

Patent Literature 1: Japanese Unexamined Patent Application Publication No. 2003-139098 (FIG. 5)

### SUMMARY OF INVENTION

### Technical Problem

In Patent Literature 1, however, the ease of processing regarding the length of the divergent taper portion is not improved. Since the divergent taper portion is very long relative to the diameter of the throat portion, difficulty in performing cutting for obtaining the divergent taper portion still disadvantageously exists.

It is an object of the present invention to provide an ejector including a nozzle whose divergent taper portion is easily processable by cutting.

### Solution to Problem

An ejector according to the invention has a nozzle having a flow path in which a motive fluid flowing from an upstream side undergoes pressure reduction and is made to flow into a mixing section provided on a downstream side. The ejector includes the flow path of the nozzle including a narrowing flow path in which the cross-sectional area of the flow path gradually decreases toward the downstream side, a constant-cross-section flow path having a substantially constant cross-sectional shape while extending from a downstream end of the narrowing flow path, the constant-cross-section flow path being continuous for a predetermined length, and a widening flow path continuous with a downstream end of the constant-cross-section flow path and in which the cross-sectional area of the flow path gradually increases toward the downstream side.

### Advantageous Effects of Invention

According to the present invention, an ejector including a nozzle whose divergent taper portion is easily processable by cutting is provided.

### BRIEF DESCRIPTION OF DRAWINGS

FIG. 1 is a schematic diagram of a refrigeration cycle apparatus 1000 according to Embodiment 1.

FIG. 2 is a schematic diagram of an ejector 103 according to Embodiment 1.

FIG. 3 is a schematic diagram of a nozzle 201 included in the ejector 103 according to Embodiment 1.

FIG. 4 is a Mollier chart of the refrigeration cycle apparatus 1000 according to Embodiment 1.

FIG. 5 illustrates the relationship between the pressure inside the nozzle, the velocity, and the void fraction and the distance from the inlet of the nozzle in a case where a cylindrical flow path length L2 is zero.

FIG. 6 illustrates flow characteristics of the ejector 103 according to Embodiment 1.

FIG. 7 is a diagram that explains the decrease of the length of a divergent taper portion 201c of the ejector 103 according to Embodiment 1.

FIG. 8 is a schematic diagram of an ejector 103 having a needle valve according to Embodiment 1.

FIG. 9 is a schematic diagram of another refrigeration cycle apparatus according to Embodiment 1.

### DESCRIPTION OF EMBODIMENTS

### Embodiment 1

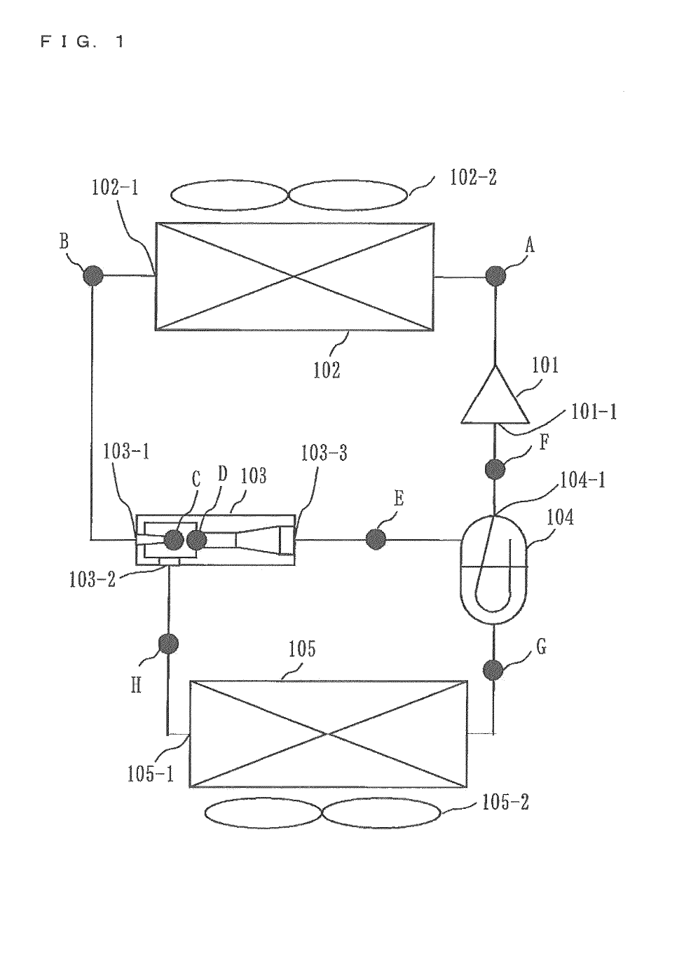

Referring to FIGS. 1 to 9, a refrigeration cycle apparatus according to Embodiment 1 will now be described.

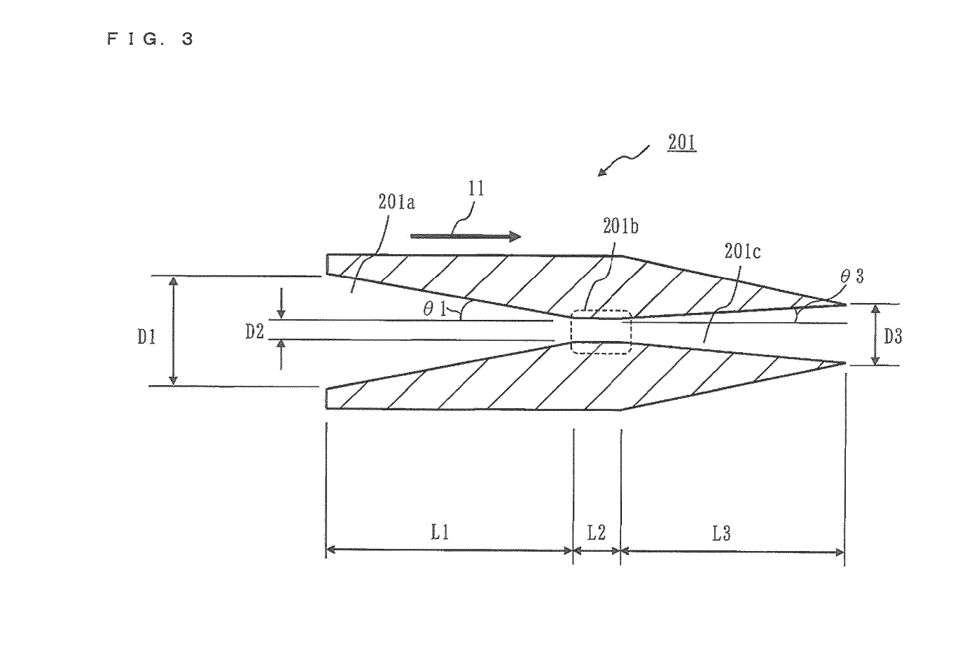

FIG. 1 is a schematic diagram of a refrigeration cycle apparatus 1000 according to Embodiment 1. The refrigeration cycle apparatus 1000 is characterized by an ejector 103. As illustrated in FIG. 3 to be referred to below, the ejector 103 is characterized by including a cylindrical flow path 201b (hereinafter also referred to as cylindrical flow path) with a flow path having a cylindrical shape provided in a nozzle 201. The ejector 103 is also characterized in that the inside diameter of the cylindrical flow path 201b, which corresponds to a throat portion, is larger than that of conventional ejectors. By providing the cylindrical flow path 201b, the length of a divergent taper portion can be reduced, and along with increase of the inside diameter of the cylindrical flow path 201b than that of conventional cases, the ease of processing by cutting is improved.

### (Refrigeration Cycle Apparatus)

The refrigeration cycle apparatus 1000 includes a compressor 101, a condenser 102 (a radiator), the ejector 103, and a gas-liquid separator 104 configured to separate a two-phase gas-liquid refrigerant that has flowed out of the ejector 103 into a liquid refrigerant and a gas refrigerant, which are connected in order by refrigerant pipings. The refrigeration cycle apparatus 1000 further includes an evaporator 105 connected to the ejector 103 and to the gas-liquid separator 104 with pipings. The ejector 103 has an inlet (103-1) for a motive fluid that is connected to a refrigerant outlet (102-1) of the condenser 102, an inlet (103-2) for a suction fluid that is connected to a refrigerant outlet (105-1) of the evaporator 105, and an outlet (103-3) from which a mixture of the motive fluid and the suction fluid flows out and that is connected to the gas-liquid separator 104. A circuit including the compressor 101, the condenser 102, the ejector 103, and the gas-liquid separator 104 forms a first refrigerant loop circuit. A circuit including the gas-liquid separator 104, the evaporator 105, and the ejector 103 forms a second refrigerant loop circuit. The condenser 102 and the evaporator 105 include fans 102-2 and 105-2, respectively.

### (Ejector 103)

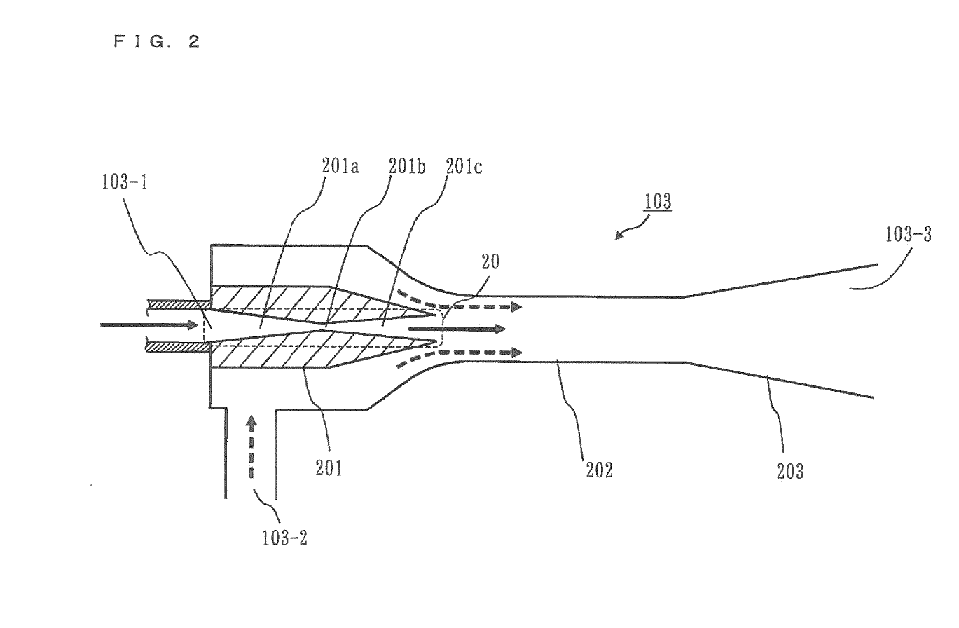

FIG. 2 is a schematic diagram of the ejector 103. The ejector 103 includes the nozzle 201, a mixing section 202, and a diffuser 203. The nozzle 201 has a flow path 20 in which the motive fluid flowing from an upstream side undergoes pressure reduction and is made to flow into the mixing section 202 provided on the downstream side. The flow path 20 of the nozzle 201 includes a convergent taper portion 201a (a narrowing flow path), the cylindrical flow path 201b (a constant-cross-section flow path), and a divergent taper portion 201c (a widening flow path). The cylindrical flow path 201b corresponds to a throat portion at which the cross-sectional area of the flow path through which the refrigerant, that is, the motive fluid, flows is the smallest.

The nozzle 201 reduces the pressure of and expands a high-pressure refrigerant that has flowed out of the condenser 102, thereby ejecting a high-velocity two-phase fluid containing a liquid refrigerant and a gas refrigerant. A refrigerant from the evaporator 105 is sucked through the inlet (103-2) for the suction fluid by utilizing the velocity energy produced by the high-velocity two-phase fluid ejected from the nozzle 201. In the mixing section 202, the refrigerant ejected from the nozzle 201 and the refrigerant sucked through the inlet (103-2) are mixed together while the pressure is increased. In the diffuser 203, the kinetic pressure of the mixed refrigerant is converted into a static pressure.

### (Shape of Nozzle Section 201)

FIG. 3 illustrates the nozzle 201 according to Embodiment 1. The cylindrical flow path 201b is a flow path having a cylindrical shape with a diameter D2 and a length L2 (hereinafter also referred to as cylindrical flow path length L2). Arrow 11 represents the direction in which the refrigerant flows. That is, the arrow is oriented toward the downstream side.

(1) The cross-sectional area of the flow path in the convergent taper portion 201a gradually decreases with a reduction from a diameter D1 to the diameter D2. The convergent taper portion 201a has a cone angle θ1 and a length “L1”.
(2) The cylindrical flow path 201b is a flow path having a cylindrical shape with the diameter D2 and the cylindrical flow path length L2.
(3) The cross-sectional area of the flow path in the divergent taper portion 201c gradually increases with an increase from the diameter D2 to a diameter D3. The divergent taper portion 201c has a cone angle θ3 and a length “L3”.
(4) The angle θ1 of the convergent taper portion 201a and the angle θ3 of the divergent taper portion are set to about 5° and 1.5° or smaller, respectively, so that the occurrence of any eddy loss that may be caused by abrupt narrowing or abrupt widening is suppressed. Hence, the length “L1” of the convergent taper portion and the length “L3” of the divergent taper portion 201c are geometrically determined by the diameter D1 of the nozzle inlet, the diameter D2 of the cylindrical flow path 201b corresponding to a throat portion, and the diameter D3 of the nozzle outlet. The cylindrical flow path length L2 is much shorter than the total length of the nozzle.
(5) The nozzle 201 of the ejector 103 may be made of any one of stainless metal, copper or copper alloys, aluminum, and the like.

### (Operations of Refrigeration Cycle Apparatus 1000)

Operations performed by the refrigeration cycle apparatus 1000 will now be described.

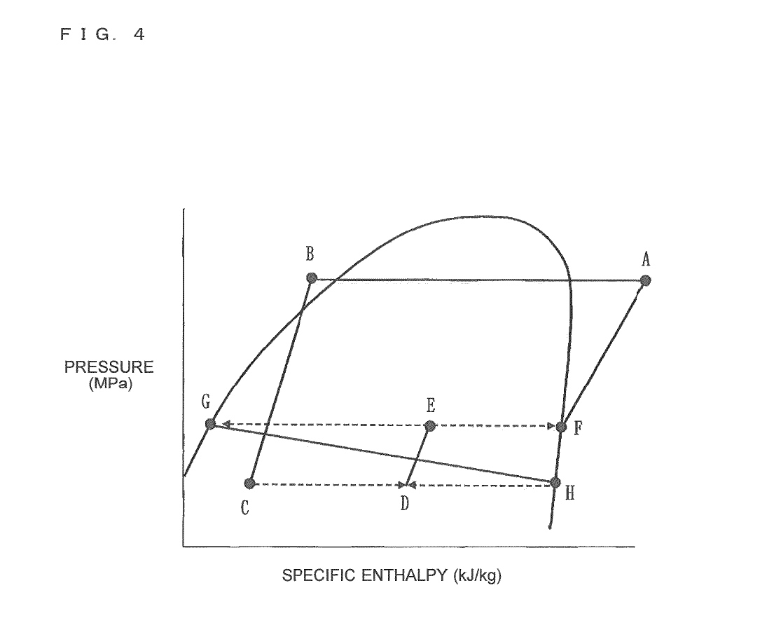

FIG. 4 is a Mollier chart of the refrigeration cycle apparatus 1000 illustrated in FIG. 1.

Referring to FIGS. 1 and 4, operations performed by the refrigeration cycle apparatus 1000 will be described. A high-temperature high-pressure gas refrigerant (state A) fed from the compressor 101 is liquefied (state B) in the condenser 102 by transferring heat and flows into the ejector 103 (as the motive fluid) through the inlet (103-1). In the nozzle 201, the motive fluid undergoes pressure reduction and expansion. Then, the motive fluid turns into an ultrafast, two-phase, gas-liquid refrigerant and flows out of the nozzle 201 (state C). With the kinetic energy produced by the motive flow flowing out of the nozzle 201, a refrigerant (suction fluid) is drawn via the inlet (103-2) for the suction fluid, whereby a mixture of the motive fluid and the suction fluid flows into the mixing section 202 (state D). In the mixing section 202, the motive fluid and the suction fluid are mixed together while exchanging their momenta with each other, whereby recovering pressure. In the diffuser 203 also, since the kinetic pressure is converted into a static pressure with the increase in the cross-sectional area of the flow path, pressure is recovered (a state E). The two-phase gas-liquid refrigerant having flowed out of the ejector 103 is separated into a gas refrigerant and a liquid refrigerant by the gas-liquid separator 104. In the gas-liquid separator 104, the gas refrigerant flows into the compressor 101 (state F), whereas the liquid refrigerant flows into the evaporator 105 (state G). The liquid refrigerant receives heat from the surroundings thereof in the evaporator 105 and is evaporated (state H), and is sucked into the ejector 103 through the inlet (103-2) for the suction fluid by the drawing effect produced by the motive fluid. Through this series of operations, a refrigerant circulation loop to the evaporator 105 (a refrigerant circulation circuit including the evaporator 105, the ejector 103, and the gas-liquid separator 104) is established.

According to the above operations, in a refrigeration cycle apparatus employing an ejector, the suction pressure of the compressor can be increased as compared with conventional refrigeration cycle apparatus, thus operating efficiency is improved.

(Case of Ejector without Cylindrical Flow Path Portion 201b)

An operation of the nozzle 201 of the ejector 103 will now be described.

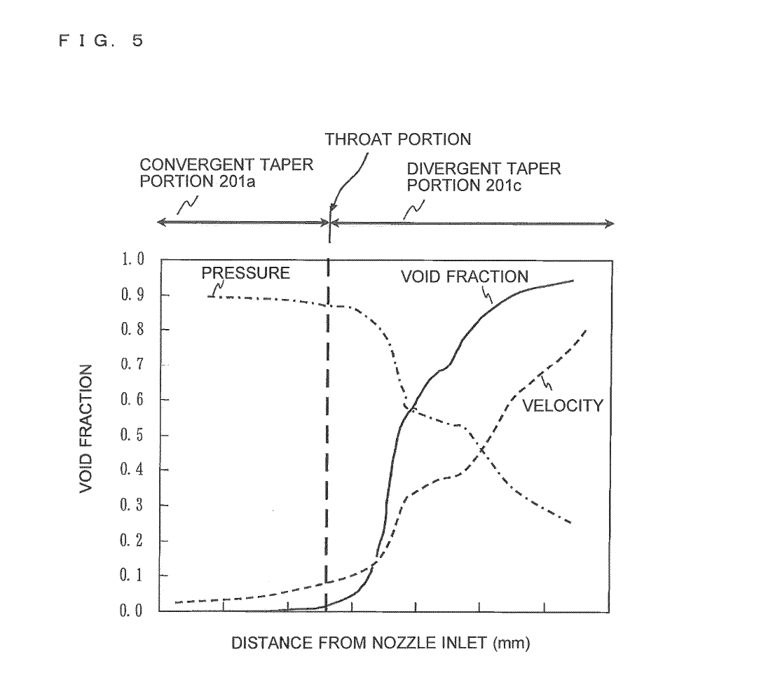

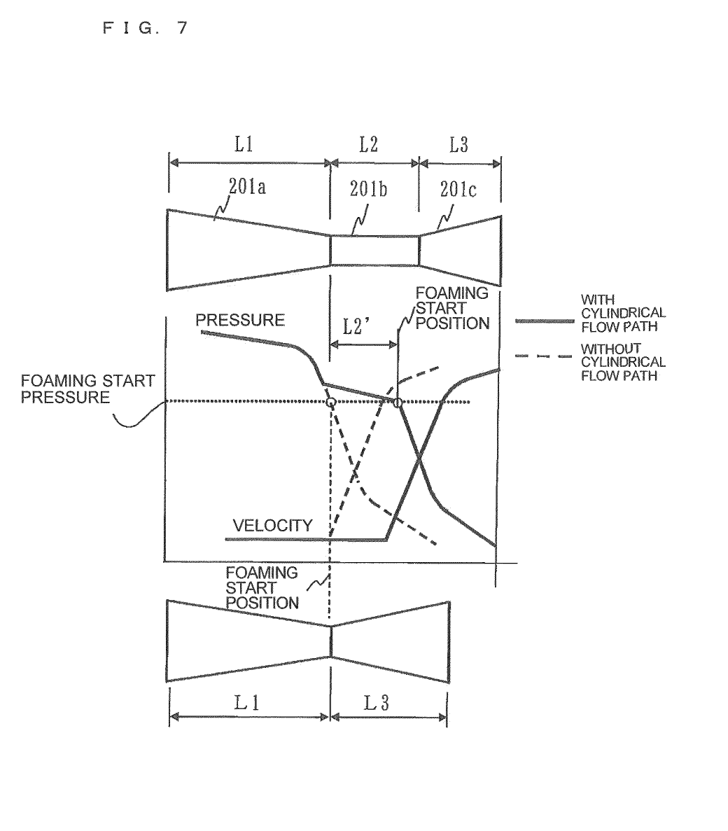

FIG. 5 illustrates the pressure inside the nozzle, the average velocity of the refrigerant, and the void fraction in a case in which there is no cylindrical flow path 201b in the nozzle 201. The scale on the vertical axis is that of the void fraction. The case in which there is no cylindrical flow path 201b refers to a case where the convergent taper portion 201a changes over to the divergent taper portion 201c directly (L2=0), as illustrated at the bottom of FIG. 7. In FIG. 5, the horizontal axis represents the distance from the nozzle inlet (the inlet (103-1) for the motive fluid), and the vertical broken line represents the position of the throat portion. Herein, the term “void fraction” refers to the occupied area ratio of the gas refrigerant when the cross-sectional area of the flow path is defined as 1. Zero void fraction is a state in which there is no gas refrigerant present and when void fraction is 1, the flow path is filled with a gas refrigerant. As illustrated in FIG. 5, the refrigerant that has flowed into the nozzle 201 undergoes pressure reduction in the convergent taper portion 201a and in the divergent taper portion 201c and starts to foam when the pressure of the refrigerant is reduced to or below the saturation pressure. The foaming increases the ratio of the gas in the flow path (the void fraction). Accordingly, the velocity of the refrigerant sharply increases. The foaming continues to occur toward the downstream side of the divergent taper portion 201c while decreasing the pressure and increasing the velocity. Accordingly, a high-velocity two-phase refrigerant is ejected from the nozzle.

(Diameter D2 of Cylindrical Flow Path 201b)

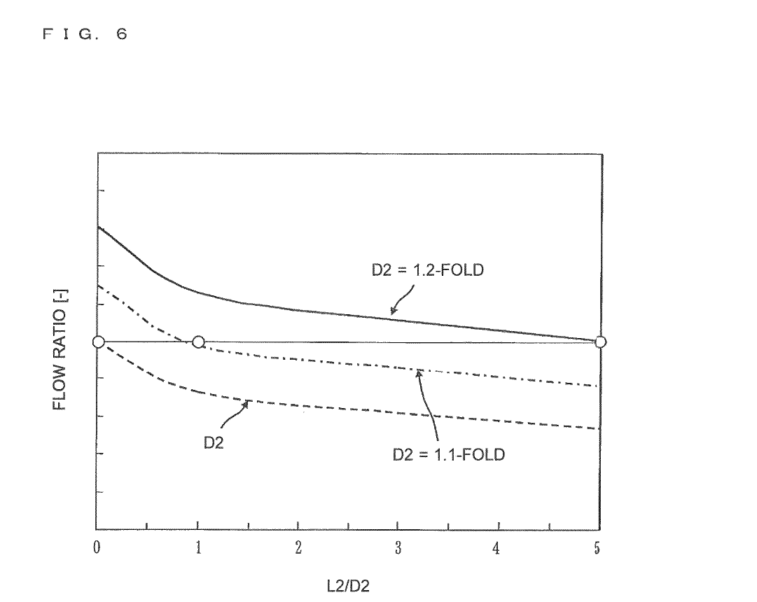

FIG. 6 illustrates flow characteristics of nozzles each including a throat portion corresponding to the cylindrical flow path 201b. The horizontal axis represents the ratio of the cylindrical flow path length L2 of the cylindrical flow path 201b to the diameter D2 of the cylindrical flow path 201b. The vertical axis represents the flow ratio when assuming the flow rate as 1 when the diameter of the throat portion is D2 and when there is no cylindrical flow path (L2=0). When the cylindrical flow path length L2 of the cylindrical flow path 201b is increased, the flow rate decreases. This is because friction loss occurring in the cylindrical flow path 201b reduces the pressure and hence reduces the saturation temperature of the refrigerant, whereby causing the refrigerant to start to foam in the cylindrical flow path 201b. The specific volume of a gas refrigerant is substantially larger than the specific volume of a liquid refrigerant. Therefore, a fluid in the form of liquid containing gas, such as a two-phase gas-liquid fluid, does not readily flow. As illustrated in FIG. 6, even when the diameter D2 of the throat portion is increased 1.1-fold and 1.2-fold, flow characteristics exhibit the same tendency with respect to L2/D2. When the diameter D2 of the throat portion is increased, the flow rate increases. According to such characteristics, the same flow rate as that of the nozzle without the cylindrical flow path (L2=0) can be achieved by providing the cylindrical flow path 201b and by increasing the diameter D2 of the throat portion. In the exemplary cases illustrated in FIG. 6, the refrigerant can be made to flow at the same flow rate as that of the nozzle without the cylindrical flow path 201b (L=0) by selecting a cylindrical flow path length L2 in which “L2/D2” becomes about 1 when the diameter D2 of the throat portion is increased 1.1-fold and by selecting a cylindrical flow path length L2 in which “L2/D2” becomes about 5 when the diameter D2 of the throat portion is increased 1.2-fold.

### (Assumed Value for Diameter D2)

In the ejector 103 according to Embodiment 1, the diameter D2 of the cylindrical flow path 201b is assumed to be 2 mm or less.

(Reduction of Length L3 of Divergent Taper Portion 201c)

FIG. 7 is a schematic diagram illustrating distributions of pressure and velocity of a refrigerant in the nozzle 201 with the cylindrical flow path 201b and in the nozzle without the cylindrical flow path 201b (L2=0). The solid lines indicate the nozzle 201 with the cylindrical flow path 201b and the broken lines indicate the nozzle without the cylindrical flow path 201b. The pressure inside the cylindrical flow path 201b decreases in the flow direction because of friction loss. When the pressure inside the cylindrical flow path 201b reaches a foaming starting pressure (the position denoted by L2′), the refrigerant, which is in a liquid state, foams and expands. Accordingly, the velocity of the refrigerant sharply increases, whereas the pressure of the refrigerant sharply decreases. Because of the friction loss occurring in the cylindrical flow path 201b, the pressure at the inlet of the divergent taper portion 201c is lower than that of the nozzle without the cylindrical flow path 201b. Hence, the pressure reduction in the divergent taper portion 201c in the case where the cylindrical flow path 201b is provided is small. Consequently, the length L3 of the divergent taper portion 201c becomes shorter than that of the nozzle without the cylindrical flow path 201b.

Friction loss ΔP occurring in the cylindrical flow path 201b can be estimated from Equation (1) given below. In accordance with Equation (1), ΔP is calculated with L2′ as a parameter. That is, with respect to a difference ΔP between an inlet pressure P_{IN} and a foaming starting pressure P_{ST} in the cylindrical flow path 201b, the foaming start position L2′ can be estimated from Equation (1).

$$\begin{matrix}[ Equation 1 ] & \\ Δ P = λ \frac{ρ \cdot {u}^{2}}{2} \cdot \frac{L {2}^{′}}{D 2} , & ( 1 )\end{matrix}$$

where λ is coefficient of friction

ρ is density, and

ν is velocity.

According to a literature, the foaming starting pressure may be a pressure in which degree of superheat of the refrigerant (difference of the refrigerant temperature and the saturation temperature) becomes 5K. The cylindrical flow path length L2 may be determined on the basis of this foaming start position L2′.

The flow rate of the refrigerant passing through the nozzle 201 is controllable by adjusting, in accordance with the cylindrical flow path length L2, the position where the refrigerant starts to foam.

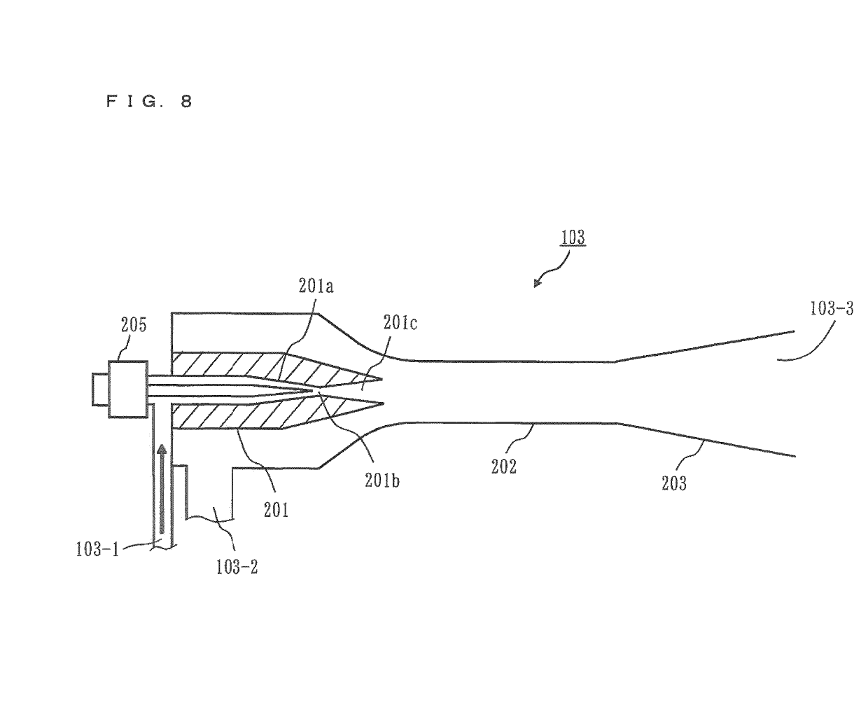

FIG. 8 is a diagram illustrating a case where an ejector 103 having a movable needle valve 205 is employed to the nozzle 201. As illustrated in FIG. 8, the ejector 103 may be fabricated as an ejector into which a movable needle valve 205 that controls the flow rate of the refrigerant is inserted.

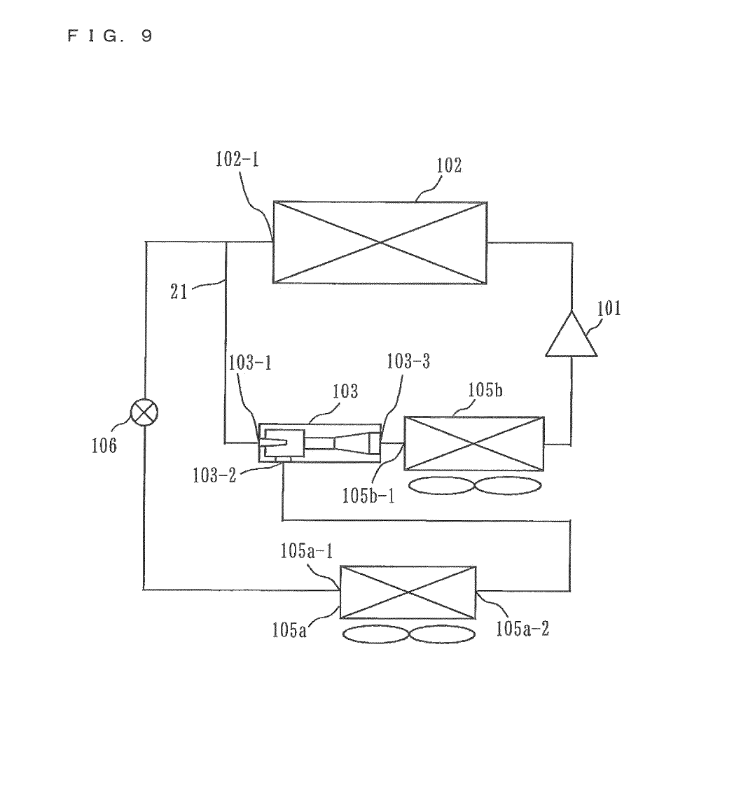

FIG. 9 is a diagram illustrating a configuration of another refrigeration cycle apparatus according to Embodiment 1. In a case where the ejector 103 is provided in the refrigerant circuit (refrigeration cycle apparatus) illustrated in FIG. 9, the same effects as those obtained by the configuration illustrated in FIG. 1 are obtained. In FIG. 9, a compressor 101, a condenser 102 (a radiator), an expansion mechanism 106, a first evaporator 105a, the ejector 103, and a second evaporator 105b are connected in order by refrigerant pipings. The inlet (103-1) of the ejector 103 for the motive fluid is connected to a branch piping 21 branching off from midway of a piping connecting the condenser 102 and the expansion mechanism 106. The inlet (103-2) of the ejector 103 for the suction fluid is connected to a refrigerant outlet (105a-2) of the first evaporator 105a. The outlet (103-3) from which the mixture of the motive fluid and the suction fluid flows out is connected to a refrigerant inlet (105b-1) of the second evaporator 105b. The expansion mechanism 106 is connected to a refrigerant inlet (105a-1) of the first evaporator 105a. A refrigerant outlet (105b-2) of the second evaporator 105b is connected to a suction port of the compressor 101. In such a case, a refrigerant having flowed out of the condenser 102 is branched to the first evaporator 105a and the ejector 103. The refrigerant having flowed out of the first evaporator 105a is sucked into the ejector 103 and undergoes pressure increase. The refrigerant having flowed out of the ejector 103 flows through the second evaporator 105b into the suction port of the compressor 101.

Note that although Embodiment 1 above describes a case where the nozzle 201 has the cylindrical flow path 201b, since the cylindrical flow path 201b is characterized in that the cross-sectional shape thereof does not change in the direction of the flow path, the cross-sectional shape is not limited to a circle and may be an ellipse or the like, as long as the cross-sectional shape does not change in the direction of the flow path. FIG. 2 illustrates a configuration in which only the convergent taper portion is provided on the upstream side of the cylindrical flow path 201b. Alternatively, a two-stage taper portion or “another cylindrical flow path+a convergent taper portion” such as the one illustrated in FIG. 8 may be provided. That is, any with a convergent taper portion in the flow path immediately before the cylindrical flow path 201b will do.

The ejector 103 according to Embodiment 1 includes the cylindrical flow path at the throat portion of the nozzle, whereby foaming is started in the cylindrical flow path. Therefore, the length L3 of the divergent taper portion can be shorter compared to that of the nozzle without the cylindrical flow path. Hence, when manufacturing the divergent taper portion 201c by cutting, the process is facilitated.

The ejector 103 according to Embodiment 1 includes the cylindrical flow path at the throat portion of the nozzle. In addition, the throat portion has an increased diameter D2. Therefore, the ejector 103 allows the refrigerant to flow at a flow rate the same as that of the nozzle without the cylindrical flow path. Moreover, since the diameter D2 is increased, the ease of processing with cutting tools in the manufacturing process is improved. Consequently, manufacturing time is reduced.

The ejector 103 according to Embodiment 1 has an increased diameter D2 of the throat portion and includes the cylindrical flow path. Therefore, machinability is improved. Hence, by finishing the cylindrical flow path 201b and the divergent taper portion 201c with, for example, a reamer or the like, the dimensional accuracy can be improved.

In the ejector 103 according to Embodiment 1, the cylindrical flow path length L2 is much shorter than the total nozzle length. Therefore, the friction loss occurring in the cylindrical flow path is very small relative to the pressure reduction caused by expansion. Hence, power conversion efficiency equivalent to that of the nozzle without the cylindrical flow path is obtained.

On the other hand, since the cylindrical flow path is provided, the total nozzle length becomes greater and material cost increases. Nevertheless, since the cylindrical flow path length L2 is short as mentioned above, the increase in material cost is negligible. The increase in the diameter of the throat portion and the reduction in the length of the divergent taper portion improve machinability. The cost reduction effect with the improvement of machinability is far greater than the increase in material cost.

In the refrigeration cycle apparatus according to Embodiment 1 (FIGS. 1 and 9) employing the ejector 103, the refrigerant used may be a fluorocarbon refrigerant or any other refrigerant. For example, the refrigerant used may be a natural refrigerant such as ammonia, carbon dioxide, or hydrocarbon (for example, propane or isobutane), or a low-GWP refrigerant such as HFO1234yf or a mixed refrigerant containing the same.

The refrigeration cycle apparatus according to Embodiment 1 is not limited to an air-conditioning apparatus and may be embodied in a refrigerator-freezer, a chiller, or a water heater.

When an ejector is introduced to a refrigeration cycle apparatus of the conventional art, the diameter of the throat portion of the nozzle included in the ejector is 0.5 to 2 mm and the length of the divergent taper portion that expands the refrigerant is 20 mm or larger. Such a configuration has a problem in that it is difficult to provide a deep narrow hole by cutting. To solve this problem, a cylindrical flow path is provided at the throat portion of the nozzle. Thus, foaming is promoted by utilizing the reduction in the pressure of the refrigerant caused by friction in the cylindrical flow path. Since foaming is thus promoted, the nozzle divergence length can be reduced. In addition, the diameter of the cylindrical flow path is made larger than that of the conventional throat portion. The shortening of the divergent taper portion 201c by employment of the cylindrical flow path and the increase in the diameter of the throat portion (the inside diameter of the cylindrical flow path) facilitate the cutting of the nozzle and reduce cost and time for manufacturing the nozzle.

### REFERENCE SIGNS LIST

101 compressor; 102 condenser; 103 ejector; 104 gas-liquid separator; 105, 105a, 105b evaporator; 201 nozzle; 201a convergent taper portion; 201b cylindrical flow path; 201c divergent taper portion; 202 mixing section; 203 diffuser; 204 suction section; 205 needle valve; 1000 refrigeration cycle apparatus.

1. An ejector including a nozzle having a flow path in which a motive fluid flowing from an upstream side undergoes pressure reduction and is made to flow into a mixing section provided on a downstream side, the ejector comprising:
the flow path of the nozzle including
a narrowing flow path in which the cross-sectional area of the flow path gradually decreases toward the downstream side,
a constant-cross-section flow path having a substantially constant cross-sectional shape while extending from a downstream end of the narrowing flow path, the constant-cross-section flow path being continuous for a predetermined length, and
a widening flow path continuous with a downstream end of the constant-cross-section flow path and in which the cross-sectional area of the flow path gradually increases toward the downstream side, wherein
the narrowing flow path takes in the motive fluid in a liquid state and allows the motive fluid in the liquid state to flow into the constant-cross-section flow path while reducing the pressure of the motive fluid in the liquid state, and
the constant-cross-section flow path allows the motive fluid in the liquid state to start to foam at a midway point of the predetermined length.

2. (canceled)

3. The ejector of claim 1, wherein each of the flow path of the narrowing flow path, the constant-cross-section flow path, and the widening flow path has a substantially circular cross-sectional shape.

4. The ejector of claim 1, wherein
the substantially constant cross-sectional shape of the constant-cross-section flow path is a circle and the circle has a diameter of 2 mm or less.

5. The ejector of claim 1, further comprising:
a needle valve provided in the flow path, the needle valve adjusting the flow rate of the motive fluid.

6. A motive fluid foaming method applied to an ejector including a nozzle having a flow path in which a motive fluid flowing from an upstream side is made to flow into a mixing section provided on a downstream side, the foaming method of the motive fluid flowing into the mixing section comprising a step of foaming the motive fluid in the liquid state at a midway point of a predetermined length of the constant-cross-section flow path,
wherein the flow path of the nozzle includes
a narrowing flow path in which cross-sectional area of the flow path gradually decreases toward the downstream side,
a constant-cross-section flow path having a substantially constant cross-sectional shape while extending from a downstream end of the narrowing flow path, the constant-cross-section flow path being continuous for a predetermined length, and
a widening flow path continuous with a downstream end of the constant-cross-section flow path and in which the cross-sectional area of the flow path gradually increases toward the downstream side.

7. A refrigeration cycle apparatus, comprising:
a compressor, a radiator, an ejector of claim 1, and a gas-liquid separator that are connected in order by refrigerant pipings and an evaporator connected to the ejector and to the gas-liquid separator,
the ejector including
an inlet for a motive fluid that is connected to a refrigerant outlet of the radiator,
an inlet for a suction fluid that is connected to a refrigerant outlet of the evaporator, and
an outlet from which a mixture of the motive fluid and the suction fluid flows out that is connected to the gas-liquid separator.

8. A refrigeration cycle apparatus, comprising:
a compressor, a radiator, an expansion mechanism, a first evaporator, an ejector of claim 1, and a second evaporator that are connected in order by refrigerant pipings,
the ejector including
an inlet for a motive fluid that is connected to a branch piping branching off from midway of a piping connecting the radiator and the expansion mechanism,
an inlet for a suction fluid that is connected to a refrigerant outlet of the first evaporator, and
an outlet from which a mixture of the motive fluid and the suction fluid flows out and that is connected to a refrigerant inlet of the second evaporator.
